(19) United States
(12) Patent Application Publication
(10) Pub. No.: US 2026/0369492 A1
(43) Pub. Date: Nov. 19, 2026

(54) SILENT TACTILE SHEET AND SILENT TACTILE SWITCH

(71) Applicant: Alps Alpine Co., Ltd., Tokyo (JP)

(72) Inventor: Fangfang CAI, Wuxi-Jiangsu (CN)

(21) Appl. No.: 19/649,714

(22) Filed: Apr. 16, 2026

(30) Foreign Application Priority Data
May 16, 2025 (CN) 202510641657.4

(51) Int. Cl. H01H 13/20; G05G 1/02; G05G 5/03; G05G 5/05

(52) U.S. Cl. CPC H01H 13/20; G05G 1/02; G05G 5/03; G05G 5/05; G05G 2505/00

(57) ABSTRACT

A silent tactile sheet is formed by sequentially stacking a protective layer, a supporting spring plate, a sound-deadening layer, a metal spring plate, and a substrate in an up-down direction. Both the metal spring plate and the supporting spring plate are formed in a dome shape having a raised central part. The protective layer is arranged on a raised side of the supporting spring plate to cover the supporting spring plate. The sound-deadening layer is arranged on a recessed side of the supporting spring plate to support the supporting spring plate, and on a raised side of the metal spring plate to cover the metal spring plate. The substrate is arranged on a recessed side of the metal spring plate to support the metal spring plate. The supporting spring plate and the metal spring plate are arranged opposite to each other with the sound-deadening layer interposed therebetween.

### CLAIM OF PRIORITY

This application claims benefit of Chinese Patent Application No. 202510641657.4 filed on May 16, 2025, which is hereby incorporated by reference.

### BACKGROUND OF THE INVENTION

### 1. Field of the Invention

The present invention relates to a silent tactile sheet and a silent tactile switch.

### 2. Description of the Related Art

It is known that, compared with related art silicone rubber keys, membrane keys provide better tactile feedback and a longer service life.

A membrane key generally includes an operation button, a protective layer, a metal spring plate, and a circuit board. The metal spring plate is located above a conductive portion of the circuit board (also referred to as a printed circuit board (PCB)) and is covered by the protective layer on which the operation button is installed. When the metal spring plate is pressed, a central part of the metal spring plate is depressed to contact circuits on the circuit board, thereby forming a conductive circuit through which current can flow. The metal spring plate is an important component of a switch, enabling the switch to be turned on and off through the depression and rebound of the metal spring plate and providing an operator with high-quality tactile feedback.

However, in the related art, the metal spring plate often generates a relatively loud operating sound when pressed. To meet market demand for silence, there is a desire to provide a silent tactile sheet or a silent tactile switch that can achieve a silent effect with a simple structure.

### SUMMARY OF THE INVENTION

In view of the above issues, the present invention provides a silent tactile sheet and a silent tactile switch that can achieve a silent effect with a simple structure and increase the overall stroke.

A silent tactile sheet of technical solution 1 is formed by sequentially stacking a protective layer, a supporting spring plate, a sound-deadening layer, a metal spring plate, and a substrate in an up-down direction. Both the metal spring plate and the supporting spring plate are formed in a dome shape having a raised central part. The protective layer is arranged on a raised side of the supporting spring plate to cover the supporting spring plate, and the sound-deadening layer is arranged on a recessed side of the supporting spring plate to support the supporting spring plate. The sound-deadening layer is arranged on a raised side of the metal spring plate to cover the metal spring plate, and the substrate is arranged on a recessed side of the metal spring plate to support the metal spring plate. The supporting spring plate and the metal spring plate are arranged opposite to each other with the sound-deadening layer interposed therebetween, and under an external pressing force, the supporting spring plate is configured to drive the metal spring plate to cause the central part of the metal spring plate to be depressed.

According to technical solution 1, by stacking the supporting spring plate above the metal spring plate, an overall stroke of the silent tactile sheet can be increased while ensuring an operating force. In addition, by providing the sound-deadening layer between the metal spring plate and the supporting spring plate, an impact force can be reduced, thereby diminishing an operating sound.

In the silent tactile sheet of technical solution 2, the supporting spring plate may have a central raised portion at its central part and three or more supporting legs extending toward the substrate at its edge part.

According to technical solution 2, the overall stroke of the silent tactile sheet can be further increased.

In the silent tactile sheet of technical solution 3, the supporting spring plate is preferably made of a metal material.

In the silent tactile sheet of technical solution 4, the sound-deadening layer may electrically insulate the supporting spring plate from the metal spring plate, and an area of the sound-deadening layer may be sufficient to cover the metal spring plate and support the supporting spring plate.

In the silent tactile sheet of technical solution 5, the sound-deadening layer is preferably made of foam and is preferably adhered to upper surfaces of the substrate and the metal spring plate by a double-sided adhesive tape.

In the silent tactile sheet of technical solution 6, the sound-deadening layer is preferably made of polyethylene terephthalate (PET) and is preferably adhered to upper surfaces of the substrate and the metal spring plate by a double-sided adhesive tape.

According to technical solutions 4 to 6, by forming the sound-deadening layer from a soft material, the impact force can be reduced and the operating sound can be diminished. In addition, by configuring the sound-deadening layer to have a size large enough to cover the metal spring plate and to be adhesively connected to the upper surface of the substrate, a contact sound between the metal spring plate and the substrate can be muffled within a limited narrow space, thereby effectively suppressing the sound.

In the silent tactile sheet of technical solution 7, an upper surface of the protective layer is preferably further provided with a columnar pressing operation portion arranged at a position on the protective layer opposite to the central part of the supporting spring plate.

According to technical solution 7, a pressing operation portion convenient for operation can be provided.

In the silent tactile sheet of technical solution 8, the pressing operation portion is preferably made of resin and is preferably cured on the upper surface of the protective layer by ultraviolet irradiation.

In the silent tactile sheet of technical solution 9, the pressing operation portion is preferably made of polyethylene terephthalate (PET) and is preferably laser-welded onto the upper surface of the protective layer.

In the silent tactile sheet of technical solution 10, the substrate is preferably a release film.

According to technical solution 10, by using a release film as the substrate, the entire silent tactile sheet can be protected from contamination and damage during storage and transportation. When the silent tactile sheet needs to be installed onto a circuit board, the release film can be peeled off to attach the adhesive sound-deadening layer to the circuit board.

In the silent tactile sheet of technical solution 11, an outer peripheral edge of the metal spring plate is preferably located within an imaginary circumference defined by the plurality of supporting legs of the supporting spring plate.

In the silent tactile sheet of technical solution 12, a deviation value between a center of the dome-shaped metal spring plate and a center of the dome-shaped supporting spring plate in a horizontal direction is preferably within 1.3 mm.

According to technical solutions 11 and 12, by limiting a relative position of the metal spring plate with respect to the supporting spring plate, the metal spring plate can be controlled well by the supporting spring plate.

A silent tactile switch of technical solution 13 includes the silent tactile sheet according to any one of technical solutions 1 to 12; and the substrate is a circuit board capable of electrically conducting with the metal spring plate with its central part depressed.

According to technical solution 13, when the substrate is a circuit board, a silent tactile switch that can achieve a silent effect with a simple structure and increase the overall stroke while ensuring the operating force can be provided.

### BRIEF DESCRIPTION OF THE DRAWINGS

FIG. 1A is a perspective view of a silent tactile sheet with a substrate omitted, and FIG. 1B is a top view of the silent tactile sheet with the substrate omitted;

FIG. 2 is an exploded perspective view of FIGS. 1A and 1B;

FIG. 3 is an exploded front view of FIGS. 1A and 1B;

FIG. 4A is a front view of FIGS. 1A and 1B in an assembled state, and FIG. 4B is a cross-sectional schematic view taken along line IVB-IVB of FIG. 1B;

FIG. 5 is a schematic view illustrating a relative positional relationship between a metal spring plate and a supporting spring plate when viewed from above;

FIG. 6 is a front view of the silent tactile sheet including the substrate; and

FIG. 7 is a graph illustrating reaction force characteristics of the silent tactile switch of Embodiment 2 and those of a related art product.

### DESCRIPTION OF THE PREFERRED EMBODIMENTS

### Embodiment 1

A silent tactile sheet and a silent tactile switch of the present invention will be described below with reference to the accompanying drawings.

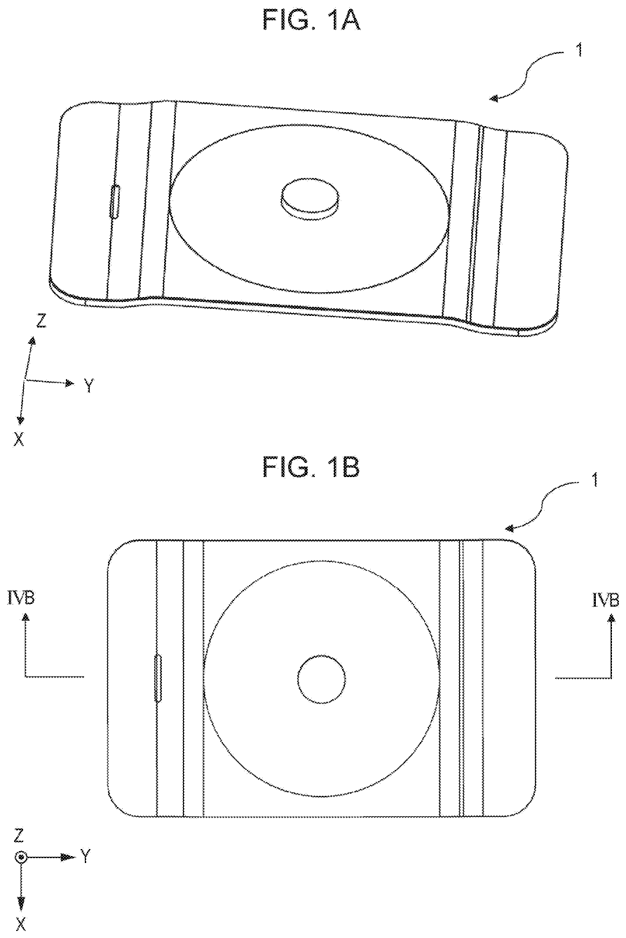

FIG. 1A is a perspective view of a silent tactile sheet with a substrate omitted, and FIG. 1B is a top view of the silent tactile sheet with the substrate omitted. In the following description, a Y direction in the drawings, which corresponds to a long-side direction of the silent tactile sheet, is referred to as a left-right direction; an X direction, which corresponds to a short-side direction of the silent tactile sheet, is referred to as a depth direction; and a Z direction, which corresponds to a stacking direction of each component in the silent tactile sheet, is referred to as an up-down direction. The X direction, the Y direction, and the Z direction are mutually perpendicular. Furthermore, although the directions indicated by the X-, Y-, and Z-directions remain consistent across the drawings, the above up-down direction (Z direction), left-right direction (Y direction), and depth direction (X direction) are used merely for convenience of explanation and may differ from the actual orientation during use.

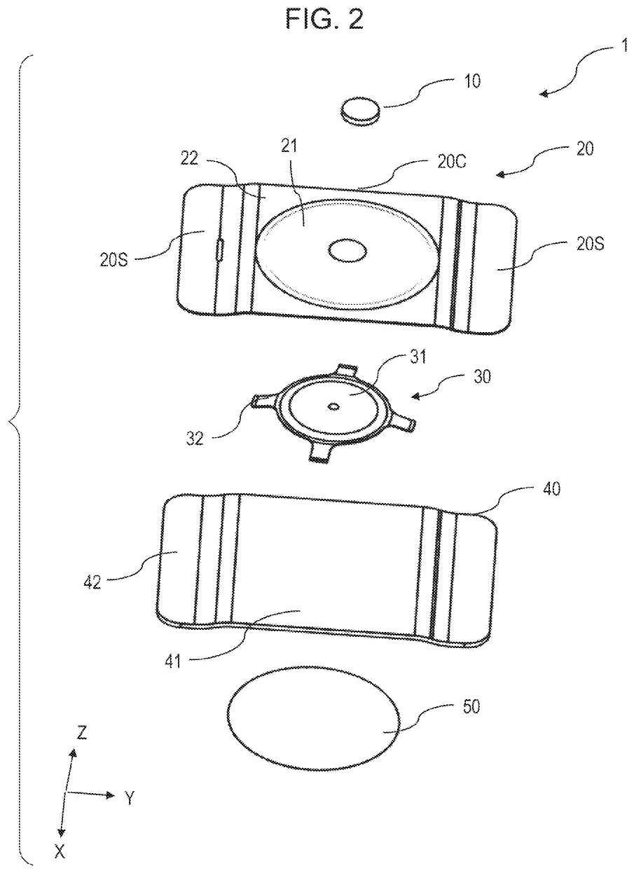

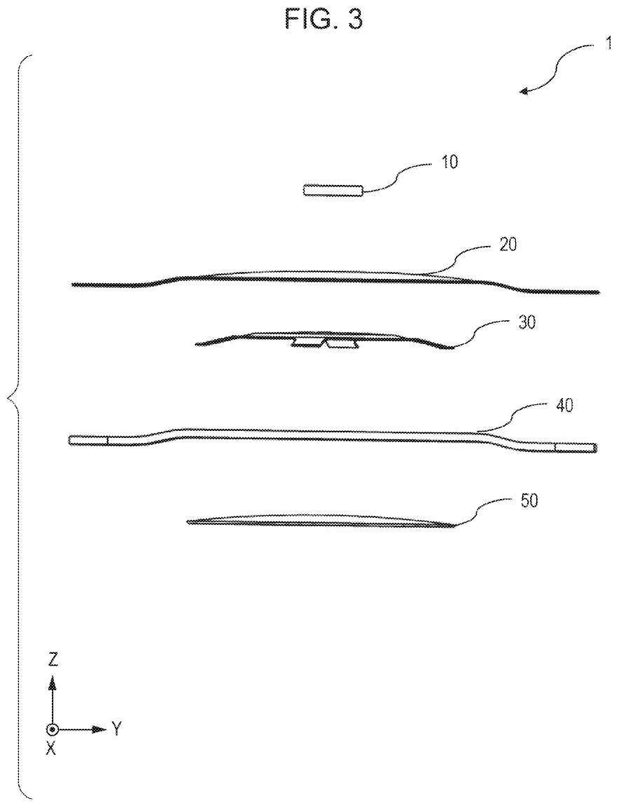

As shown in FIGS. 1A to 3, the silent tactile sheet 1 includes a pressing operation portion 10, a protective layer 20, a supporting spring plate 30, a sound-deadening layer 40, a metal spring plate 50, and a substrate 60 (not shown). The pressing operation portion 10, the protective layer 20, the supporting spring plate 30, the sound-deadening layer 40, the metal spring plate 50, and the substrate 60 (not shown) are sequentially stacked from top to bottom to form the silent tactile sheet 1.

The pressing operation portion 10 is formed in a columnar shape and is arranged on an upper surface of the protective layer 20 at a position opposite to a central part of the supporting spring plate 30. The pressing operation portion 10 is located on a side of the silent tactile sheet 1 closer to an operator and, through pressing operation by the operator, causes elastic deformation of the supporting spring plate 30 and the metal spring plate 50 located below.

The pressing operation portion 10 can be made of resin. When installing the pressing operation portion 10 onto the protective layer 20, the resin-made pressing operation portion 10 can be cured on the upper surface of the protective layer 20 by ultraviolet irradiation.

In addition, the pressing operation portion 10 can be made of PET, and the PET-made pressing operation portion 10 can be laser-welded onto the upper surface of the protective layer 20.

The protective layer 20 is arranged above the supporting spring plate 30, the sound-deadening layer 40, the metal spring plate 50, and the substrate 60 (not shown). When viewed from above, the protective layer 20 has a substantially quadrilateral shape, with an area sufficient to cover the supporting spring plate 30 and the sound-deadening layer 40 located below.

The protective layer 20 includes a central part 20C and two end portions (first end portions) 20S located on both sides in an extending direction of the central part 20C. An arc-shaped protruding portion 21 protruding upward and a flat portion 22 connected to an outer periphery of the arc-shaped protruding portion 21 are formed on the central part 20C. The two end portions (first end portions) 20S descend from junctions with the flat portion 22 to form steps respectively.

The arc-shaped protruding portion 21 of the protective layer 20 is arranged opposite to and bonded with the supporting spring plate 30, and the end portions 20S of the protective layer 20 are arranged opposite to and bonded with end portions of the sound-deadening layer 40. The above describes one example of the shape of the protective layer 20, and other shapes can also be adopted provided that good adhesion between the protective layer 20, the supporting spring plate 30, and the sound-deadening layer 40 can be achieved.

The supporting spring plate 30 is formed in a dome shape having a raised central part. The raised part is substantially opposite to the arc-shaped protruding portion 21 of the protective layer 20, and the sound-deadening layer 40 that functions to support the supporting spring plate 30 is arranged on a recessed side of the supporting spring plate 30.

The supporting spring plate 30 is generally made of a metal material. However, since the supporting spring plate 30 does not function as a conductive element in the present invention, it can also be made of other materials.

The supporting spring plate 30 has a central raised portion 31 at its central part and a plurality of supporting legs 32 extending downward, i.e., toward the substrate at its edge part. Four supporting legs 32 are shown in the drawings, but this is merely an example. It suffices as long as three or more supporting legs 32 are provided.

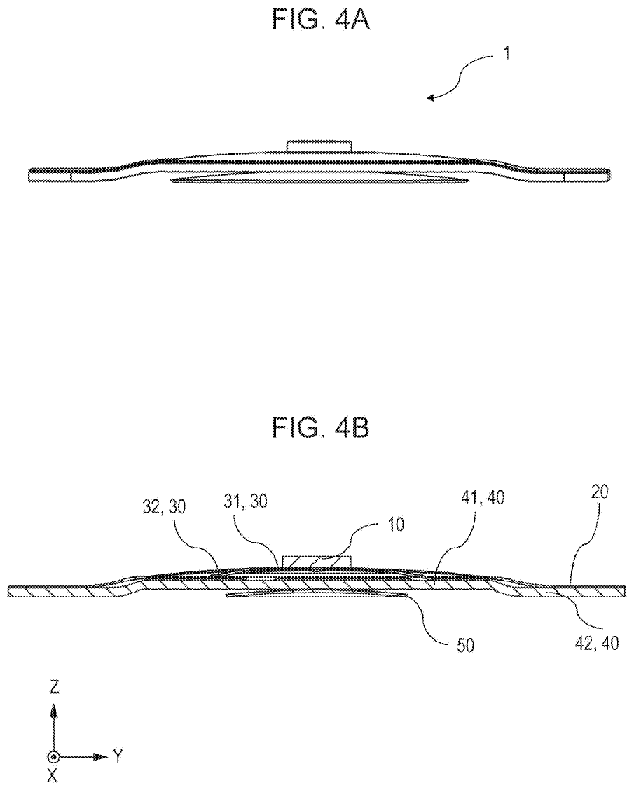

As shown in FIG. 4B, when the silent tactile sheet 1 is not pressed, the supporting legs 32 of the supporting spring plate 30 are supported by the sound-deadening layer 40, and the central raised portion 31 of the supporting spring plate 30 is separated from the sound-deadening layer 40. When the pressing operation portion 10 is pressed, the pressing operation portion 10 presses the central raised portion 31 of the supporting spring plate 30 through the protective layer 20, causing the central raised portion 31 to be depressed and subsequently press against the metal spring plate 50 through the sound-deadening layer, leading to the depression of the central portion of the metal spring plate 50. When the metal spring plate 50 is directly arranged on a circuit board, the depressed metal spring plate 50 can be electrically connected to circuits on the circuit board, thereby achieving electrical conduction of a switch.

The sound-deadening layer 40 is arranged on the recessed side of the supporting spring plate 30 to support the supporting spring plate 30. When viewed from above, the sound-deadening layer 40 has a substantially quadrilateral shape, with an area sufficient to cover the metal spring plate 50 and support the supporting spring plate 30. The sound-deadening layer 40 has a flat central spacing portion 41 and two end portions (second end portions) 42 located on both sides in an extending direction of the central spacing portion 41 and descending from junctions with the central spacing portion 41 to form steps.

The supporting spring plate 30 and the metal spring plate 50 are arranged opposite to each other with the sound-deadening layer 40 interposed therebetween, specifically with the central spacing portion 41 of the sound-deadening layer 40 interposed therebetween. The sound-deadening layer 40 electrically insulates the supporting spring plate 30 from the metal spring plate 50.

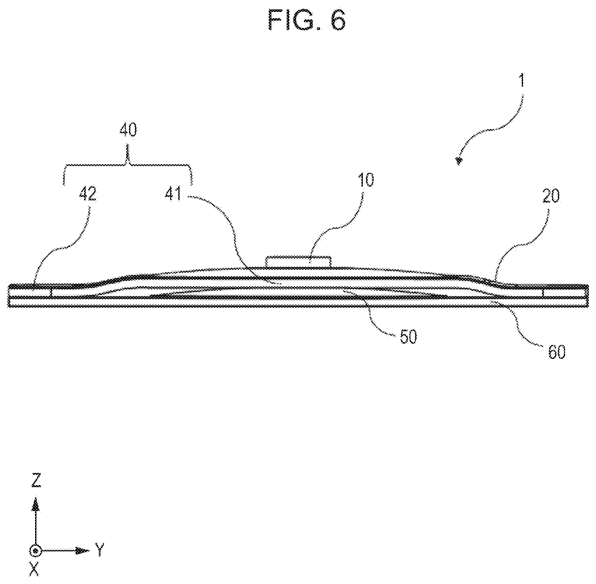

The sound-deadening layer 40 can be made of foam and is adhered to upper surfaces of the metal spring plate 50 and the substrate 60 described later by, for example, a double-sided adhesive tape. Specifically, as shown in FIG. 6, the central spacing portion 41 of the sound-deadening layer 40 is adhered to a portion of the upper surface of the metal spring plate 50, and the end portions (second end portions) 42 of the sound-deadening layer 40 are adhered to the upper surface of the substrate 60.

In addition, the sound-deadening layer 40 can be made of polyethylene terephthalate (PET) and is adhered to the upper surfaces of the metal spring plate 50 and the substrate 60 described later by, for example, a double-sided adhesive tape. Specifically, as shown in FIG. 6, the central spacing portion 41 of the sound-deadening layer 40 is adhered to a portion of the upper surface of the metal spring plate 50, and the end portions (second end portions) 42 of the sound-deadening layer 40 are adhered to the upper surface of the substrate 60.

In addition, upper surfaces of the two end portions (second end portions) 42 of the sound-deadening layer 40 are fixed to the two end portions (first end portions) 20S of the protective layer 20 respectively, so that the supporting spring plate 30 is enclosed within a limited space defined by the protective layer 20 and the sound-deadening layer 40, thereby suppressing an operating sound generated by the supporting spring plate 30.

The metal spring plate 50 is made of metal and is a spring plate capable of electrically conducting with a circuit board. Both the metal spring plate 50 and the supporting spring plate 30 are formed in a dome shape having a raised central part. A raised side of the metal spring plate 50 is covered by the sound-deadening layer 40, and a recessed side of the metal spring plate 50 is arranged on the substrate 60 described later and supported thereby.

By configuring the metal spring plate 50 as a dome shape having a relatively small operating force, the contact force between the metal spring plate 50 and the substrate 60 can be reduced, thereby mitigating the impact force, diminishing the operating sound, and achieving a silent effect.

In addition, by stacking the supporting spring plate 30 and the metal spring plate 50, requirements for operating force can be satisfied while compensating for insufficient stroke that would occur when the metal spring plate 50 is used alone.

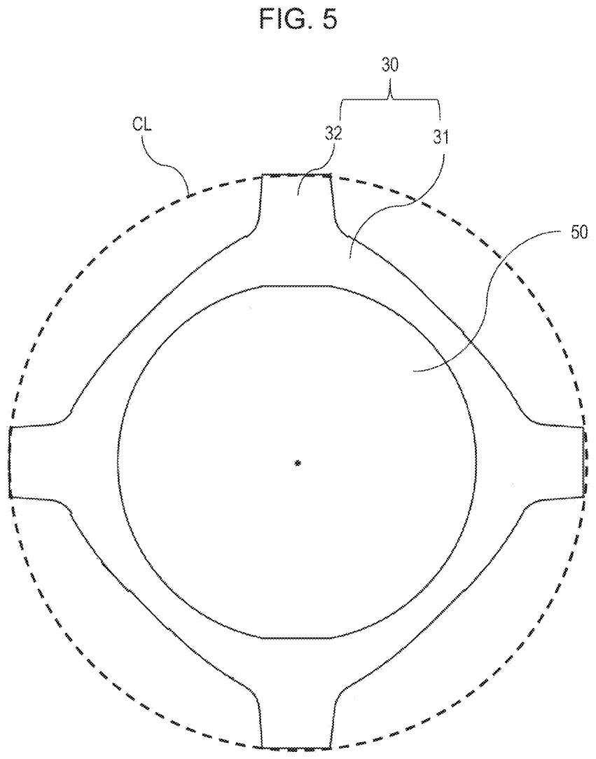

FIG. 5 is a schematic view illustrating a relative positional relationship between the metal spring plate and the supporting spring plate when viewed from above. For convenience of illustration, the sound-deadening layer interposed therebetween is omitted in this figure. As shown in FIG. 5, the metal spring plate 50 has a substantially circular shape when viewed from above. To obtain favorable tactile feel and operating force, it is desirable that a center of the metal spring plate 50 and a center of the supporting spring plate 30 be substantially concentric when viewed from above. Even if a slight deviation exists, a deviation value between the center of the dome-shaped metal spring plate 50 and the center of the dome-shaped supporting spring plate 30 in a horizontal direction should be within 1.3 mm. Furthermore, an outer peripheral edge of the metal spring plate 50 can be located inside the central raised portion 31 of the supporting spring plate 30 as shown in the figure, or can extend beyond the outer peripheral edge of the central raised portion 31 and be located outside it; however, the outer peripheral edge of the metal spring plate 50 at least should be located within an imaginary circumference CL defined by the plurality of supporting legs of the supporting spring plate 30.

As shown in FIG. 6, the substrate 60 is arranged at the lowermost position of the silent tactile sheet 1. When viewed from above, the substrate 60 has a substantially quadrilateral shape and is, for example, formed to be approximately the same size as the sound-deadening layer 40. In this embodiment, the substrate 60 is formed of a release film. During transportation and storage, the release film protects other parts of the silent tactile sheet 1 and can be removed when the silent tactile sheet 1 needs to be installed onto a circuit board.

In the case of the silent tactile sheet 1, lower surfaces of the two end portions (second end portions) 42 of the sound-deadening layer 40 are adhered to both ends of the upper surface of the release film serving as the substrate 60. In the case of a silent tactile switch, the release film serving as the substrate 60 is removed, and the sound-deadening layer 40 is re-adhered to the circuit board such that the metal spring plate 50 aligns with the circuits of the circuit board. Accordingly, the metal spring plate 50 is enclosed within a limited space defined by the sound-deadening layer 40 and the circuit board, thereby suppressing the operating sound generated by the metal spring plate 50 during switching.

In addition, preferably, a dimension in the up-down direction of parts of the silent tactile sheet 1 other than the substrate 60 ranges from 0.63 mm to 0.83 mm, a stroke during pressing operation ranges from 0.15 mm to 0.35 mm, a click ratio during pressing operation ranges from 20% to 50%, and a dimension in the up-down direction of the supporting spring plate 30 is greater than that of the metal spring plate 50.

Previously, when a metal spring plate having a conductive function was used alone, problems of relatively small operating force and insufficient stroke were encountered. In this embodiment, by arranging the supporting spring plate above the metal spring plate, the stroke during pressing can be increased while ensuring the operating force. In addition, in this embodiment, a plurality of supporting legs are arranged at the outer periphery of the supporting spring plate, thereby further increasing the stroke during pressing. Furthermore, by interposing the supporting spring plate between the protective layer and the sound-deadening layer and interposing the metal spring plate between the sound-deadening layer and the substrate, the operating sound between the supporting spring plate and the metal spring plate as well as the operating sound between the metal spring plate and the substrate can be reduced, thereby achieving a silent effect.

### Embodiment 2

Embodiment 2 relates to a silent tactile switch. A difference from Embodiment 1 is that the substrate 60 is not a release film but a circuit board. Since other structures are the same as those of Embodiment 1, repeated description thereof is omitted. In this case, a protective layer 20, a supporting spring plate 30, a sound-deadening layer 40, a metal spring plate 50, and a circuit board are sequentially stacked in an up-down direction to form the silent tactile switch.

In a related art tactile switch, a high-operating-force metal spring plate having a diameter of 6 mm is used as a conductive spring plate to satisfy customer requirements for greater product height and operating force. It is known that the greater the operating force of the metal spring plate, the higher its height, the larger its stroke, the greater its elastic deformation, and consequently, the louder an operating sound generated.

To diminish the large operating sound caused by elastic deformation resulting from high operating force, in the silent tactile switch of Embodiment 2, a structure in which two metal spring plates having a relatively small operating force are stacked is adopted to satisfy customer requirements for greater operating force and product height, while the operating sound is reduced by adding the sound-deadening layer.

To satisfy overall stroke requirements, in this embodiment, the supporting spring plate 30 is arranged above the metal spring plate 50 with the sound-deadening layer 40 interposed therebetween. The arrangement of the supporting spring plate 30 increases the overall stroke of the tactile switch.

In addition, in the silent tactile switch of this embodiment, the sound-deadening layer 40 is provided that covers the metal spring plate 50 and the circuit board (substrate) 60 and is located between the supporting spring plate 30 and the metal spring plate 50. The sound-deadening layer 40 not only diminishes the operating sound generated when the metal spring plate 50 contacts the circuit board (substrate) 60, but also mitigates the operating sound generated between the supporting spring plate 30 and the metal spring plate 50 when the supporting spring plate 30 presses the metal spring plate 50.

In addition, by arranging the supporting legs 32 having a buffering effect at an outer periphery of the supporting spring plate 30, the operating sound generated when the supporting spring plate 30 presses the metal spring plate 50 can be further diminished.

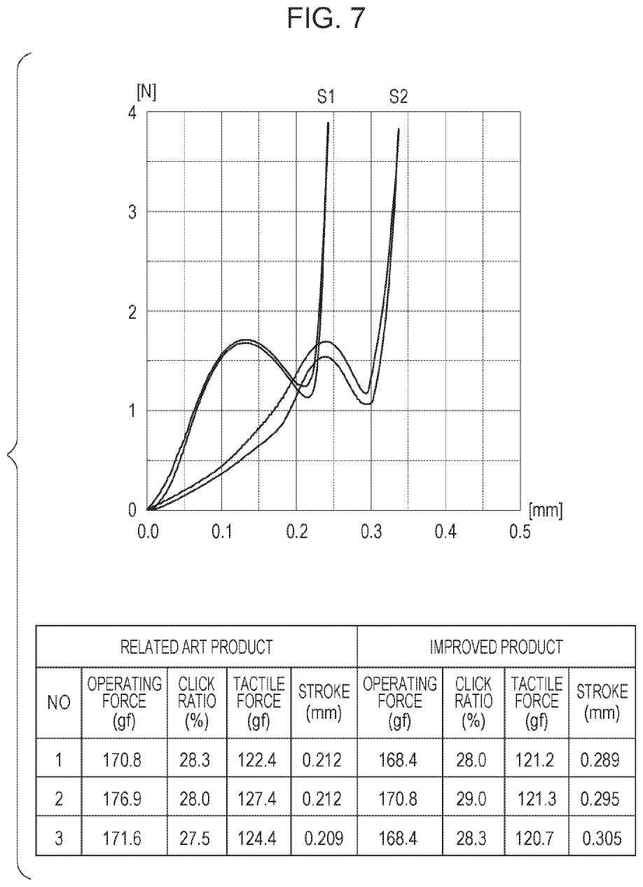

FIG. 7 is a graph illustrating reaction force characteristics of the silent tactile switch of Embodiment 2 and those of a related art product. In the graph shown in FIG. 7, a vertical axis represents resultant reaction force [N], and a horizontal axis represents stroke [mm] during pressing operation. S1 denotes a reaction force characteristic curve of a related art product used as a comparative product, and S2 denotes a reaction force characteristic curve of an improved product of the silent tactile switch of Embodiment2.

In the table shown in FIG. 7, multiple sets of data of the related art product and the improved product are compared. Among these, operating force indicates a maximum value occurring during pressing of the switch, tactile force indicates a minimum value occurring during pressing of the switch, and click ratio indicates a relative degree of change in force during pressing, which is typically calculated using a formula: click ratio=(operating force−tactile force)/operating force×100%.

As shown in FIG. 7, compared with the related art product, the improved product of Embodiment 2 shows no significant difference in the operating force and the click ratio, which are indicators of switch performance. In terms of the overall stroke, the stacked spring plate structure of the improved product provides a larger stroke.

In addition, although not shown in the figure, since, compared with the related art product, the improved product of Embodiment 2 is further provided with the sound-deadening layer that covers the metal spring plate and the substrate and is located between the supporting spring plate and the metal spring plate, a silent effect superior to that of the related art product can be achieved. If supporting legs having a buffering effect are arranged at the outer periphery of the supporting spring plate 30, an even more improved silent effect than the related art product can be achieved.

In summary, by configuring the silent tactile switch of Embodiment 2, similarly to the silent tactile sheet of Embodiment 1, a silent effect can be achieved with a simple structure, and the overall stroke can be increased while ensuring the operating force.

Although several embodiments of the present invention have been described above, these embodiments are provided as examples and are not intended to limit the scope of the invention. These new embodiments may be implemented in various other forms, and various omissions, substitutions, and modifications may be made without departing from the spirit of the invention. Such embodiments and modifications thereof are included within the scope and spirit of the invention and are also included within the scope of the invention as defined by the appended claims and equivalents thereof.

What is claimed is:

1. A silent tactile sheet, wherein the silent tactile sheet is formed by sequentially stacking a protective layer, a supporting spring plate, a sound-deadening layer, a metal spring plate, and a substrate in an up-down direction;
both the metal spring plate and the supporting spring plate are formed in a dome shape having a raised central part;
the protective layer is arranged on a raised side of the supporting spring plate to cover the supporting spring plate, and the sound-deadening layer is arranged on a recessed side of the supporting spring plate to support the supporting spring plate;
the sound-deadening layer is arranged on a raised side of the metal spring plate to cover the metal spring plate, and the substrate is arranged on a recessed side of the metal spring plate to support the metal spring plate; and
the supporting spring plate and the metal spring plate are arranged opposite to each other with the sound-deadening layer interposed therebetween, and under an external pressing force, the supporting spring plate is configured to drive the metal spring plate to cause the central part of the metal spring plate to be depressed.

2. The silent tactile sheet according to claim 1, wherein
the supporting spring plate has a central raised portion at its central part and three or more supporting legs extending toward the substrate at its edge part.

3. The silent tactile sheet according to claim 2, wherein
the supporting spring plate is made of a metal material.

4. The silent tactile sheet according to claim 1, wherein
the sound-deadening layer electrically insulates the supporting spring plate from the metal spring plate, and an area of the sound-deadening layer is sufficient to cover the metal spring plate and support the supporting spring plate.

5. The silent tactile sheet according to claim 1, wherein
the sound-deadening layer is made of foam and is adhered to upper surfaces of the substrate and the metal spring plate by a double-sided adhesive tape.

6. The silent tactile sheet according to claim 1, wherein
the sound-deadening layer is made of polyethylene terephthalate (PET) and is adhered to upper surfaces of the substrate and the metal spring plate by a double-sided adhesive tape.

7. The silent tactile sheet according to claim 1, wherein
an upper surface of the protective layer is further provided with a columnar pressing operation portion arranged at a position on the protective layer opposite to the central part of the supporting spring plate.

8. The silent tactile sheet according to claim 7, wherein
the pressing operation portion is made of resin and is cured on the upper surface of the protective layer by ultraviolet irradiation.

9. The silent tactile sheet according to claim 7, wherein
the pressing operation portion is made of polyethylene terephthalate (PET) and is laser-welded onto the upper surface of the protective layer.

10. The silent tactile sheet according to claim 1, wherein
the substrate is a release film.

11. The silent tactile sheet according to claim 2, wherein
an outer peripheral edge of the metal spring plate is located within an imaginary circumference defined by the plurality of supporting legs of the supporting spring plate.

12. The silent tactile sheet according to claim 11, wherein
a deviation value between a center of the dome-shaped metal spring plate and a center of the dome-shaped supporting spring plate in a horizontal direction is within 1.3 mm.

13. A silent tactile switch, comprising:
the silent tactile sheet according to claim 1; wherein
the substrate is a circuit board capable of electrically conducting with the metal spring plate with its central part depressed.
